(19) United States
(12) Patent Application Publication
(10) Pub. No.: US 2010/0109959 A1
(43) Pub. Date: May 6, 2010

(54) MONO- OR MULTI-FREQUENCY ANTENNA

(75) Inventor: Jean-Philippe Coupez, Le Relecq Kerhuon (FR)

Correspondence Address: PAULEY PETERSEN & ERICKSON, 2800 WEST HIGGINS ROAD, SUITE 365, HOFFMAN ESTATES, IL, 60169, US

(73) Assignee: Groupe Des Ecoles Des Telecommunications (ENST Bretagne), Paris (FR)

(21) Appl. No.: 12/447,363

(22) PCT Filed: Oct. 26, 2007
(86) PCT No.: PCT/EP07/61549

§ 371 Date: Dec. 18, 2009

(30) Foreign Application Priority Data
Oct. 27, 2006 (FR) 0609448

(51) Int. Cl. H01Q 9/00; H01P 11/00

(52) U.S. Cl. 343/745; 29/600

(57) ABSTRACT

The invention relates to a transmission/reception antenna having one or more given operating frequencies, comprising: at least one metallic member (2) provided or to be provided opposite a mass plane (3) for providing a capacitive function; and an inductive member (5); characterised in that the metallic member (2) and the inductive member (5) have general dimensions lower than λ/10, where λ is the operational wavelength, the metallic member (2) and the inductive member (5) defining together a resonator circuit at a frequency corresponding to the operational wavelength, and the metallic member (2) comprising discontinuities which represent the origin of radiation loss during operation.

### TECHNICAL FIELD

The present invention relates to mono- or multi-frequency antennas and more specifically to those which may be put onboard portable telecommunications devices.

### STATE OF THE ART

The antenna is an inevitable component of a portable telecommunications device.

The development of mobile radio applications as well as the development of new telecommunications standards implies the availability of antennas capable of being put onboard different types of hardware.

Antenna solutions are therefore sought which are particularly performing in size, volume and weight.

Miniaturization of the antennas has, these recent years, created a strong passion on behalf of the scientific and industrial community.

Solutions of antennas, so-called “patch” antennas, with planar metal radiant structures are conventionally known. Folded “patch” antennas or even patch antennas with slots are notably known.

However, the metal patterns in these structures have typically dimensions which are fractions of the operating wavelength (for example a half-wave structure, a quarter-wave structure, etc.) so that they still remain in particular significantly bulky.

### PRESENTATION OF THE INVENTION

The present invention proposes an antenna solution which may have multi-frequency miniature architecture, and which may be made in a simple way and at low cost.

The invention proposes an emission/reception antenna with one or more given operating frequencies, including at least one metal component positioned or intended to be positioned facing a ground plane in order to provide a capacitive function, an inductive component, characterized in that the metal component and the inductive component are of general dimensions less than λ/10 where λ is an operating wavelength, the metal component and the inductive component defining together a resonant circuit at the frequency corresponding to this operating wavelength, the metal component having discontinuities which during operation, are the origin of radiation losses.

The present invention also relates to telecommunications devices including at least such an emission/reception antenna.

The invention further proposes a method for making an emission/reception antenna including at least one metal component, positioned or intended to be positioned facing a ground plane in order to provide a capacitive function, an inductive component, characterized in that said at least one metal component and the inductive component are of general dimensions less than λ/10 where λ is an operating wavelength and in that said at least one metal component and inductive component are cut out in a same metal foil.

### PRESENTATION OF THE FIGURES

Other features and advantages of the invention will become further apparent from the following description which is purely illustrative and non-limiting and should be read with reference to the appended figures wherein:

FIG. 1 illustrates an electrical diagram of an antenna with three resonant circuits,

FIG. 2 illustrates the adaptation response of a three-frequency antenna with a transparent excitation probe,

FIG. 3 illustrates the adaptation response of a three-frequency antenna with an excitation probe having an electrical effect,

FIG. 4 illustrates a mono-frequency antenna according to the invention,

FIG. 5 illustrates a few exemplary solutions of a mono-frequency antenna,

FIG. 6 illustrates an exemplary antenna with three resonators/three frequencies,

FIG. 7 illustrates an electrical diagram of a three-frequency antenna having frequency agility,

FIG. 8 illustrates the adaptation response of a mono-frequency antenna with frequency agility for a first set of parameters,

FIG. 9 illustrates the adaptation response of a mono-frequency antenna with frequency agility for a second set of parameters,

FIG. 10 illustrates a mono-frequency antenna having a frequency agility,

FIG. 11 illustrates a three-frequency antenna according to the first embodiment,

FIG. 12 illustrates a three-frequency antenna according to the second embodiment,

FIG. 13 illustrates the adaptation and transmission responses at 2.36 GHz of a three-frequency antenna according to the invention,

FIG. 14 illustrates the adaptation and transmission responses at 5.04 MHz of a three-frequency antenna according to the invention,

FIG. 15 illustrates the adaptation and transmission responses at 8.31 GHz of a three-frequency antenna according to the invention.

### DETAILED DESCRIPTION OF THE INVENTION

### General Structure/Modelling

FIG. 1 illustrates the electrical diagram of a possible antenna solution.

This antenna includes n radiant resonator(s) (with n being an integer larger than or equal to 1), each resonator being formed by localized components defining together a structure which may be modelled as a RLC resonator.

In the case when n is larger than 1, these resonators are in parallel. In this case, in FIG. 1, this is a three-frequency antenna, including three resonators RᵢLᵢCᵢ (i=1, 2, 3) in parallel.

More specifically, each resonator comprises a localized metal component which with a ground plane allows the formation of a capacitive function Cᵢ (i=1, 2, 3).

This ground plane forms the reference plate of the capacitive component.

This localized metal component has the particularity of not being radiant at the surface, but of having discontinuities (at the edges for example) which are the origin of radiation losses.

This “radiation loss” function at the discontinuities which this metal component has, is modelled in FIG. 1 by the resistors Rᵢ (i=1, 2, 3).

Moreover, each resonator also comprises one or more localized components defining the inductive function.

Notably, in the case of a structure with several resonators like the one which is modelled in FIG. 1, the different resonators include a common inductive portion (induction function L), the latter being in series with different inductive portions specific to each resonator (inductive functions Lᵢ-L where Lᵢ corresponds to the inductance value of the resonator i).

The resonator(s) is(are) powered by an excitation probe.

In the case of several resonators in parallel, the latter is connected to the inductive portions Lᵢ-L specific to each resonator through the common inductive portion L. The connection point P is in particular selected so that this antenna is matched with respect to a real reference impedance value Z₀ and this for all the operating frequencies of this antenna. It will be noted that consequently Z₀ is necessarily less than the value min {Rᵢ}.

The excitation probe may introduce an additional inductive effect, in this case modelled in FIG. 1 by an inductive component of value L_{probe}.

When the antenna of FIG. 1 is matched, the three RᵢLᵢCᵢ (i=1, 2, 3) circuits operate at frequencies close to their resonance frequency.

It is known to one skilled in the art that the resonance frequency of a parallel RᵢLᵢCᵢ circuit is given by 1/(2π(LᵢCᵢ)^{1/2}) where Lᵢ and Cᵢ are the values of the inductance expressed in henries (H) and of the capacitance (capacitor) expressed in farads (F).

Here, because of the common inductive portion 1, the three resonance circuits are not entirely decoupled, thus their operating frequency is not exactly the resonance frequency specific to each resonator.

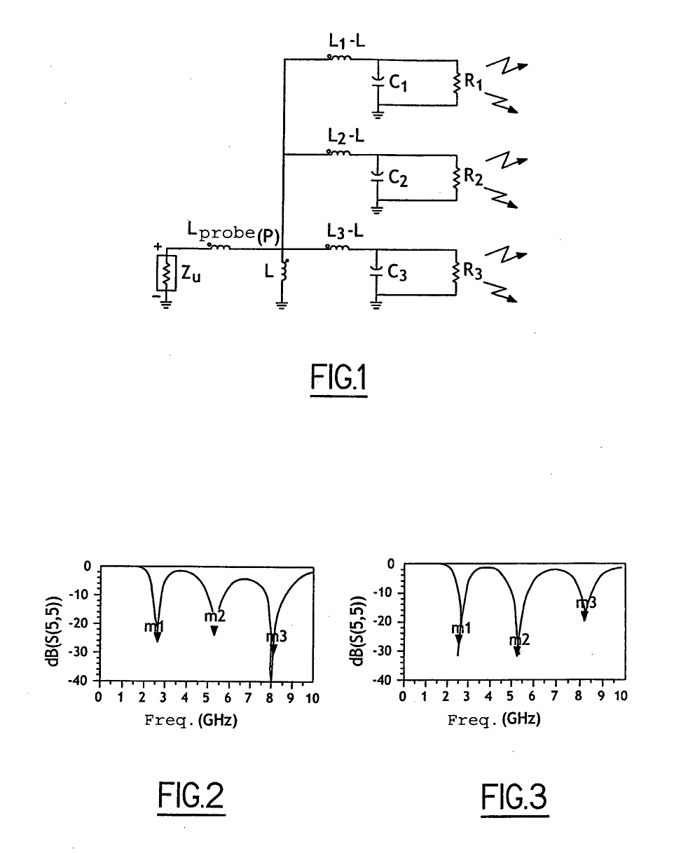

FIG. 2 illustrates the adaptation response of the antenna according to FIG. 1 operating a frequency of 2.45 GHz (m1), 5.15 GHz (m2) and 8.00 GHz (m3). The reference impedance Z₀ is set to 50Ω. The values of the capacitors are C₁=0.55 pF, C₂=0.20 pF and C₃=0.15 pF, the values of the inductive components are L₁-L=5.85 nH, L₂-L=3.65 nH, L₃-L=2.10 nH and L=1.95 nH, the values of the resistive components are R₁=750Ω, R₂=850Ω, and R₃=950Ω.

On this example, the excitation probe has zero electrical effect modelled by L_{probe}=0.00 nH, it is therefore electrically transparent and therefore does not add any electric component at the input of the antenna.

However, in practice, the excitation probe may introduce a non-zero inductive effect.

In FIG. 3, the adaptation response of a three-frequency antenna is provided when the excitation probe introduces a non-zero inductive effect (here L_{probe}=1.00 nH).

Via an adjustment of the value of the components, the operating frequencies are identical with that of FIG. 2. The components of the antenna providing the result of FIG. 3 have the values C₁=0.55 pF, C₂=0.22 pF C₃=0.28 pF, L₁-L=5.55 nH, L₂-L=3.00 nH, L₃-L=0.90 nH, L=2.25 nH, R₁=750Ω, R₂=850Ω and R₃=800Ω.

It should be noted that the matching is not quite the same as the one obtained with the antenna of FIG. 2, the values of the S₁₁ parameter (modulus of the reflection coefficient) being slightly different.

Case of a Mono-Frequency Antenna

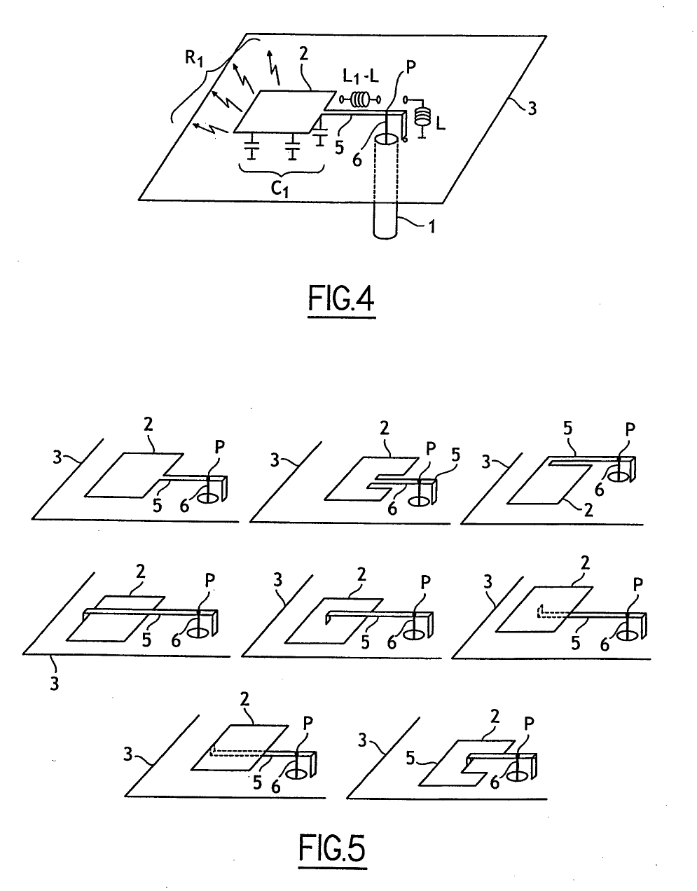

FIG. 4 shows an exemplary mono-frequency antenna according to the principles discussed above.

Capacitive Function and Radiation

The capacitive function Cᵢ is obtained by the positioning of two metal plates facing each other, separated by a dielectric medium (air or any other dielectric material).

One of these plates (plane 2) forms the metal component having discontinuities (in this case, edges) which are a source of radiation loss.

Thus, the radiation phenomenon is caused by the discontinuities, in this case localized on the perimeter of the capacitive component, this source being modelled by the resistance Rᵢ seen in parallel from the capacitance Cᵢ.

The radiation is associated with the presence of discontinuities on an open propagation structure; these discontinuities will then be the location of losses on this structure, due to the coupled electromagnetic field towards the surrounding medium (typically free space).

The other one of these plates (plane 3) forms a ground plane, considered as the reference plate of the capacitive component.

The parameters for dimensioning the capacitive function are the form factors of the plate (2D surfaces, 3D shapes), their dimensions, their spacing as well as the characteristics of the dielectric medium contained between them (air or other dielectric material, either a homogenous medium or not).

The physical dimensions of this capacitance, and in particular of the plate 2, are selected so that they remain very small relatively to the wavelength λ corresponding to the resonance frequency of the resonator (typically with a dimension less than λ/10), which induces a semi-localized or even a localized character for this component.

Conventionally, it is the size of the plate 2 which conditions the size of the antenna. As this will have been understood, therefore the localized or even semi-localized character of this component advantageously leads to an antenna of small size.

Inductive Component

The inductive component is achieved by a conductive component 5 having dimensional characteristics such that the inductive nature of this component is preferred.

This may for example be a conductive strip formed in a conductive structure of very small width, the physical length of which remains also very small relatively to λ so that this component, just like the capacitive component, may have a semi-localized or even localized character. Generally, the dimensioning parameters of this component are its form factor and its dimensions (surfaces of two dimensions or even of three dimensions).

This conductive component 5 having an inductive character is connected at its ends in two points respectively positioned on each of both plates of the capacitive component formed by the radiant component 2 and the ground plane 3.

This leads to an electrical diagram for a parallel RᵢLᵢCᵢ type resonator.

Excitation Circuit

In order to power the antenna, an excitation circuit 1 is connected at a point noted as P, of the inductive component 5 so as to divide this component into two sections, so that the size of both sections leads to inductive components with respective values L henries and L₁-L henries. It is then clearly apparent as introduced earlier that it is the geometry which initiates the inductive effect.

The position of point P is selected so that the impedance as seen at the input of the resonator is equal to Z₀. The antenna is then matched, and the component radiates at the targeted frequency (from the electrical point of view, the resonating circuit is in resonance).

The excitation circuit 1 may for example be a coaxial probe, the central core 6 of which is connected (soldered) at P to the inductive component 5 and the external cylindrical conductor 1 is connected (soldered) on the ground plane 3.

It should be noted that several parallel mounting configurations between the capacitive component and the inductive component are possible.

Possible Examples of Configuration

In FIG. 5, a few exemplary solutions of a mono-frequency antenna with a single resonator are given as an illustration but not as a limitation, according to several geometries of the plate 2.

The resonator may indeed assume several shapes, with which the integration possibilities of the antenna according to the invention may be advantageously increased.

Case of a Multi-Frequency Antenna

Telecommunications systems may operate, for example according to the standards: WiMAX, WIFI, GSM, UMTS, etc., each of these standards being able to operate at several frequencies (multi-band systems).

Structure

A multi-frequency antenna is obtained by combining several resonators in parallel like the ones described earlier, each of them corresponding to a given operating frequency.

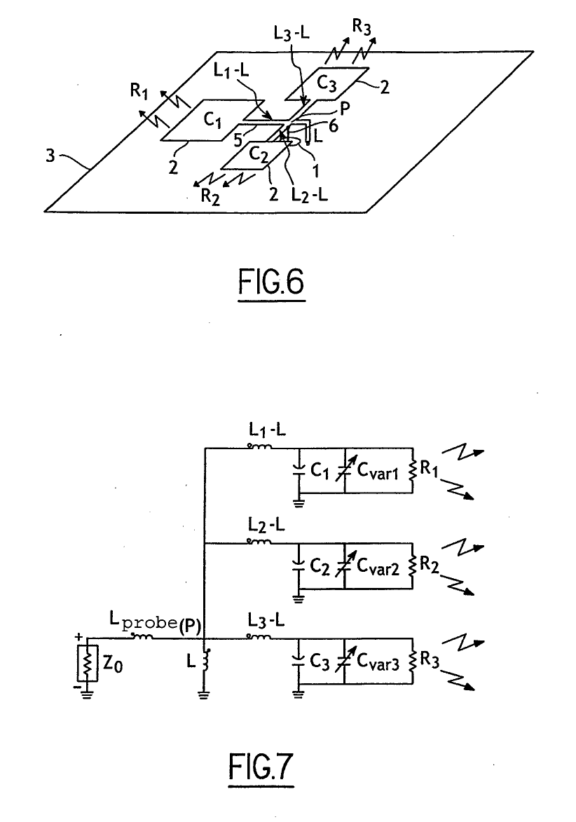

An exemplary antenna with three resonators is given in FIG. 6 (corresponding to three different frequency bands).

Each antenna includes a ground plane 3 common to all the resonant components.

The plates 2 with radiant edges are facing the ground plane 3 thereby forming the capacitive components C₁, C₂ and C₃.

Each plate 2 is connected to the excitation circuit via the inductive component 5.

The different portions of the component 5 between the point P and the plates 2 form inductive components of values L₁-L, L₂-L and L₃-L, respectively. The inductive portion L of the component 5 common to the three resonators is connected to the ground plane 3.

Advantageously, the plates 2 and the inductive component 5 are formed in a sole and single structure, which provides simplification for making such antennas.

Alternatively, the plates 2, the inductive component 5 consisting of inductive portions L and Lᵢ-L (i=1, 2, 3) and the ground plane 3 are formed in a sole and same structure.

As this will have been understood, in such a setup, the resonators are not completely decoupled since they share a same inductive portion L. It is then apparent that the operating frequencies of the antenna do not exactly correspond to the resonance eigenfrequencies of the different resonators. The point P common to all the inductors is then selected so as to match the antenna to Z₀, this for all the operating frequencies.

With the position of the point P it is also possible to define the sizes of the portions of the component 5 dedicated to the inductive components associated with each resonator.

Frequency Agility

The antenna solutions which have just been described may have frequency agility which may be simply applied.

The frequency agility of an antenna gives the possibility of adjusting the operating frequency(ies) according to several values, by which the possibilities of use of the systems integrating such antennas may be increased.

The frequency agility is obtained by “acting” on one of the reactive components of the resonator, Lᵢ or Cᵢ.

For example in FIG. 7, the block diagram of the antenna with frequency agility is illustrated, showing three variable capacitances Cvarᵢ (i=1, 2, 3) respectively mounted in parallel on each capacitance Cᵢ (i=1, 2, 3) these variable capacitances for example enable adjustment of a capacitance value in the range [0.00 pF; 0.50 pF]. Thus the variability of the capacitive component of each RᵢLᵢCᵢ circuit enables each circuit to have a variable resonance frequency, this without degrading the matching of the antenna (i.e. without changing the input impedance), the components being selected ad hoc beforehand.

The same principle of course applies to the case of a “mono-resonator” antenna.

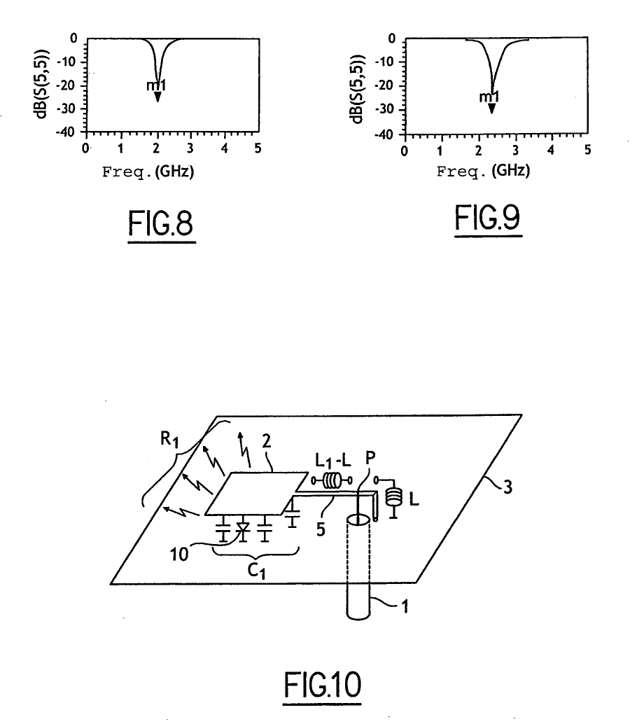

In FIG. 8, the adaptation response of a mono-resonator antenna with variable frequency is illustrated, as shown above. The operating frequency is 1.97 GHz, the variable capacitance is adjusted to Cvar₁=0.50 pF, the other components have the values C₁=0.50 pF, L₁-L=4.85 nH, L=1.95 nH and R₁=750Ω.

In FIG. 9, the adaptation response of the same antenna as the one in FIG. 8 is illustrated with Cvar₁=0.00 pF. The operating frequency is then 2.84 GHz.

Of course, frequency agility may be obtained by acting on parameters other than the capacitance (variable inductance, etc.).

Preferably, an electronic component will be added in parallel on the capacitive component, which electronic component under the effect of a variable power supply voltage will have a capacitive effect which is specific to it and which is also itself variable, thereby allowing the desired effect to be achieved.

Many electronic components have such characteristics, for example varactor diodes or Schottky diodes.

In FIG. 10, an exemplary application of a mono-frequency antenna is illustrated, having such frequency agility. The diode 10 with a capacitive effect is connected in parallel on the capacitive component formed by the metal component 2 and the ground plane 3.

Production Methods

Several manufacturing methods may be contemplated.

These methods ought to be simple in order to contribute to reducing the cost of the antenna.

A simple and technological solution consists of using a metal foil, pre-cut according to the geometry of the antenna and more particularly to that of the resonators.

By metal foil is meant a metal sheet with small thickness (a few tenths of a millimeter).

According to a first embodiment, the metal foil is first cut out according to the geometry of the plates 2 and of the inductive component 5. The foil is then folded and soldered on the ground plane 3 to the lower end of the inductive portion L of the component 5. According to this first embodiment, the ground plane 3 is uncorrelated from all the other components forming the antenna.

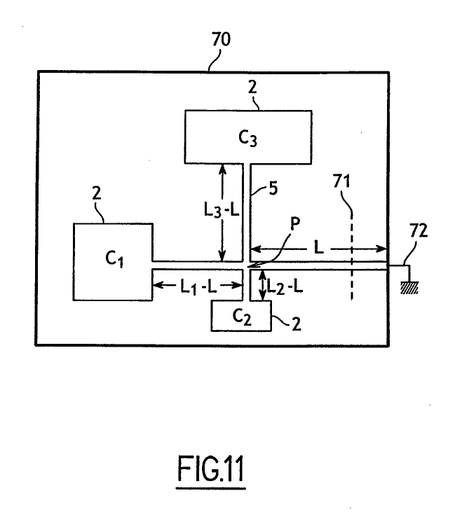

In FIG. 11, an exemplary structure is illustrated as it would be cut out in the metal foil 70, delimited by the contour in a thick line wherein the radiant components 2 and the inductive component 5 consisting of the inductive portions of respective values Lᵢ-L (i=1, 2, 3) associated with each resonator and L are cut out in a sole and same structure.

The resulting antenna in this example is a three-frequency antenna.

In this first embodiment, it is understood that the ground plane (forming the reference plate of the capacitive component) is made separately; this is for example the casing of a portable device, connected to the ground of the device.

The structure formed by the radiant components 2 and the inductive component 5 after its being cut out in the foil 70, is for example folded along the dotted line 71 in order to facilitate its connection, via a soldering point, to its support, the ground plane schematized in FIG. 7 by the component numbered as 72. The excitation probe will be connected at point P.

According to a second embodiment, the reference plate forming a ground plane 3 as well as the plates 2 and the inductive component 5 consisting of inductive portions of respective values Lᵢ-L (i=1, 2, 3) associated with each resonator and L, are formed in a same metal foil. The ground plane is then in a material of same nature as that of the other components of the antenna.

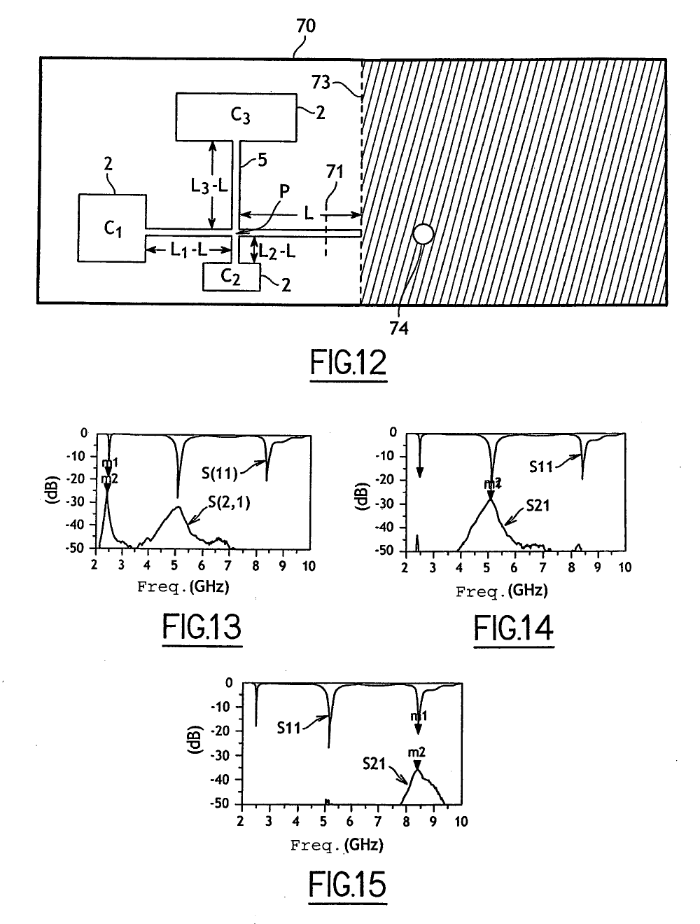

In FIG. 12, the metal foil 70 is illustrated as a thick line, in which the components 2 and 5 are cut out. The hatched portion is the portion of the foil which will be used as a ground plane. The obtained structure will be folded along the dotted lines 71 and 73 so that the ground plane will be facing the radiant components 2 on the one hand and for “adjusting” the distance between the radiant components 2 and the ground plane on the other hand. An opening 74 is pierced in the portion of the foil forming the ground plane in order to be able to let through the central core of the excitation probe, the end of which will be connected to the point P and the external cylindrical conductor on the ground plane 3.

Prototypes

In order to validate the principles of the antennas which have just been described, prototypes are made and tested in adaptation and in transmission.

In FIGS. 13, 14 and 15, the adaptation and transmission responses of a prototype of a three-frequency antenna are illustrated. The latter operates at 2.36 GHz, 5.04 GHz, and 8.31 GHz with very good matching (modulus of the reflection coefficient S₁₁ of the order of −20 dB or even less) for these three frequencies. The antenna was also tested in transmission, i.e. by establishing a radio link between said antenna and wire dipoles optimized on each of the frequencies.

The antenna was tested in transmission by establishing a radio link between the antenna and a dipole at each of the operating frequencies of the antenna, this at a distance of 20 cm.

In FIGS. 13, 14 and 15, the point m2 of the transmission response S₂₁ actually indicates that the antenna radiates at its operating frequencies.

The antenna according to the present invention may advantageously be integrated in all multi-band multi-frequency systems for which the criteria of size and cost prove to be primordial.

In particular, the antenna according to the invention is particularly adapted to onboard systems such as mobile terminals or further wireless telecommunications systems.

Moreover, because of the size of the antenna, the latter may perfectly be used in the case of multi-antenna systems where the networking of several antennas is required (MIMO (Multiple Input Multiple Output) systems, Smart Antennas systems, etc.).

1. An emission/reception antenna with one or more given operating frequencies including:
at least one metal component (2) positioned or intended to be positioned facing a ground plane (3) in order to provide a capacitive function,
an inductive component (5),
characterized in that the metal component (2) and the inductive component (5) are of general dimensions less than λ/10 where λ is an operating wavelength, the metal component (2) and the inductive component (5) defining together a circuit resonating at the frequency corresponding to this operating wavelength, the metal component (2) having discontinuities which, during operation, are the origin of radiation losses.

2. The antenna according to claim 1, characterized in that at least one portion (Lᵢ-L) of the inductive component (5) appears as a metal strip which is of a single piece with the metal component (2) and extends the latter.

3. The antenna according to claim 1, characterized in that it is a mono-frequency antenna and comprises a single resonator circuit.

4. The antenna according to claim 1, characterized in that it is a multi-frequency antenna and comprises several resonator circuits mounted in parallel.

5. The antenna according to claim 4, wherein at least one portion of the inductive component appears as a metal strip which is of a single piece with the actual component and extends the latter characterized in that the different metal components (2) and the metal strips which extend them, are of a single piece with a metal strip which forms an inductive portion (L) common to the whole of the resonators.

6. The antenna according to claim 1, characterized in that said at least one metal component (2), the metal strips which extend them and the ground plane (3) are formed as a single part.

7. The antenna according to claim 1, characterized in that it includes means capable of controlling frequency agility of at least one resonator.

8. The antenna according to claim 7, characterized in that the means capable of controlling the frequency agility are positioned in parallel on the capacitive component of at least one resonator.

9. The antenna according to claim 8, characterized in that the means capable of controlling the frequency agility include at least one electronic component so that under the effect of a variable power supply, said electronic component has a variable capacitive effect.

10. The antenna according to claim 7, characterized in that the means capable of controlling the frequency agility are of the varactor diode of schottky diode type.

11. The antenna according to claim 1, characterized in that said antenna is powered by means of an excitation probe connected at a point (P) common to all the resonators.

12. A telecommunications device, characterized in that it includes at least one emission/reception antenna as defined according to any of the preceding claims.

13. A method for making an emission/reception antenna including:
at least one metal component (2), positioned or intended to be positioned facing a ground plane (3) in order to provide a capacitive function,
an inductive component (5),
characterized in that as the metal component (2) and the inductive component (5) are of general dimensions less than λ/10 when λ is an operating wavelength, said metal component (2) and the inductive component (5) are cut out in a single piece in a same metal foil.

14. The method according to claim 13, characterized in that the ground plane (3) is also cut out in the same metal foil, the thereby formed structure being folded so that the ground plane (3) is facing the metal components (2).

15. The method according to claim 13, characterized in that the ground plane is made independently of the metal component and of the inductive component.
